(19) United States
(12) Patent Application Publication
(10) Pub. No.: US 2012/0318132 A1
(43) Pub. Date: Dec. 20, 2012

(54) Ceramic Composite Materials and Their Production

(75) Inventors: Richard Ian Todd, Oxford (GB); Amartya Mukhopadhyay, Oxford (GB)

(73) Assignee: ISIS INNOVATION LIMITED, Oxford, Oxfordshire (UK)

(21) Appl. No.: 13/510,350

(22) PCT Filed: Nov. 17, 2010
(86) PCT No.: PCT/GB10/51917

§ 371 Date: Aug. 28, 2012

(30) Foreign Application Priority Data
Nov. 17, 2009 (GB) 0920106.2

(51) Int. Cl. C04B 35/10; F41H 5/08; F41H 7/00; F41H 5/02

(52) U.S. Cl. 89/36.02; 501/153; 501/152; 264/681; 89/917

(57) ABSTRACT

According to the present invention, a ceramic composite material may be formed by a method comprising the steps preparing a solid solution comprising aluminium oxide, a second component comprising a cation in a first valent state, and a dopant, wherein the dopant is present in an amount of not more than 1000 ppm by weight of the solid solution; and carrying out a treatment on the solid solution to form the ceramic composite material, wherein the treatment changes the valent state of said cation to a second valent state, forming a ceramic composite material comprising grains containing aluminium oxide and a precipitate of particles comprising the cation in the second valent state. The materials may be useful in the manufacture of various products, including wear resistant products and armour.

### FIELD OF THE INVENTION

This invention relates to ceramic composite materials, including ceramic nanocomposite materials, and to methods for their production. In particular, the invention relates to alumina-based ceramic composite materials. The materials may be useful in the manufacture of various products, including wear resistant products and armour.

### BACKGROUND TO THE INVENTION

Alumina (aluminium oxide; Al₂O₃) is an important structural ceramic material having generally good wear and impact resistance. Alumina has been used widely, e.g. in wear resistance parts and components in industry, and in armour, including armour for personnel and vehicles. However, alumina only has a moderate strength and fracture toughness (about 350 MPa and about 3 MPa m^{1/2} respectively).

Alumina-based nanocomposite materials are known and comprise mainly alumina, with the addition of a fine dispersion (e.g. less than 500 nm) of a second ceramic phase throughout the material. Alumina-based nanocomposite materials may be more wear resistant and/or more impact resistant than alumina. For example, ceramic nanocomposite materials such as Al₂O₃—SiC comprising nanocrystalline SiC in an alumina matrix have been found to be stronger and more wear resistant than alumina. Al₂O₃—TiC and Al₂O₃—TiCN—SiC nanocomposite materials have also been found to exhibit improved properties compared with alumina.

However, despite possessing desirable properties, alumina-based nanocomposite materials have not been manufactured on a commercial scale to date. Without wishing to be bound by theory, it is thought that prior attempts to produce alumina-based nanocomposite materials have been inhibited by the covalent second phase nanoparticles being used. For example, the presence of SiC may inhibit sintering. Consequently, hot pressing, hot isostatic pressing or spark plasma sintering may need to be used to form the material. However, these procedures can be expensive and are not versatile, making it difficult to produce large or complicated parts. Although sintering aids have been developed in order to alleviate some of these problems, high temperatures are still required to form the materials. The amount of second phase which can be included in the material, and hence the improvement in properties obtained, may also be limited. Furthermore, it is thought that these processes can be sensitive to small changes in conditions and are therefore considered to be unreliable.

An alternative method is to use less refractory, oxide nanoparticles, but during normal sintering these can coarsen and adhere to the grain boundaries. Consequently, it may not be possible to obtain a fine uniform dispersion of the second phase throughout the material. Thus, once again, processes such as hot pressing or spark plasma sintering may need to be used in order to form the materials.

The production of ceramic nanocomposite materials by in situ formation of nano-sized particles has been proposed. Here, nanocomposite materials are formed by precipitation of nano-sized particles during aging of supersaturated solid solutions. For example, heating of (Al₁₋ₓ, Ti³⁺)₂O₃ solid solutions containing a maximum of 0.6 cation % Ti in an oxidizing atmosphere has been found to result in the precipitation of submicron-sized TiO₂ needles within the matrix grains of polycrystalline Al₂O₃, with coarser Al₂TiO₅ precipitates forming at the triple point corners of the matrix grain boundaries (see Langensiepen et al, J. Mater. Sci., 1983, 18, 2771-2776). More recently, it has been reported that alumina-based nanocomposites may be formed by precipitation of nanocrystalline magnesium aluminium spinel (MgAl₂O₄) during aging in a reducing atmosphere of a supersaturated, charge compensated solid solution of Mg²⁺ and Ti⁴⁺ ions in Al₂O₃ containing Mg²⁺ and Ti⁴⁺ ions (see Wang et al, J. Am. Ceram. Soc., 2000, 83(4), 933-936).

### SUMMARY OF THE INVENTION

According to the present invention, a ceramic composite material may be formed by a method comprising the steps of:
preparing a solid solution comprising aluminium oxide (Al₂O₃), a second component comprising a cation in a first valent state, and a dopant, wherein the dopant is present in an amount of not more than 1000 ppm by weight of the solid solution; and
carrying out a treatment on the solid solution to form the ceramic composite material, wherein the treatment changes the valent state of said cation to a second valent state, forming a ceramic composite material comprising grains containing aluminium oxide (Al₂O₃) and a precipitate of particles comprising the cation in the second valent state.

The present invention allows alumina-based ceramic composite materials to be produced which may have improved properties, e.g. improved strength, toughness, wear resistance and/or impact resistance, compared with alumina. Moreover, the materials may be produced using relatively cheap, micron or submicron powders, rather than expensive nanopowders of the type normally employed in mixed powder fabrication routes.

### BRIEF DESCRIPTION OF THE DRAWINGS

FIGS. 1a to 1c show backscattered electron-scanning electron microscopy (BSE-SEM) images of Al₂O₃—Fe₂O₃ solid solutions which have been subjected to different treatments.

FIGS. 2a to 2c show BSE-SEM images of Al₂O₃—Fe₂O₃ solid solutions comprising yttria (˜250 ppm) which have been subjected to different treatments.

FIG. 3 shows abrasive wear rates, as measured for monolithic alumina, Al₂O₃—Fe₂O₃ solid solutions and Al₂O₃—FeAl₂O₄ nanocomposites developed on reduction aging at 1450° C., both in the presence and absence of yttria.

FIG. 4 shows the effect of the duration of aging treatment on abrasive wear rate for Al₂O₃—FeAl₂O₄ nanocomposite materials, both in the presence and absence of yttria (referred to as A10FY and A10F respectively).

FIGS. 5a and 5b show the room temperature fracture toughness (K_{lc}) and flexural strength (σ_{f}) of nanocomposite materials developed by reduction aging of yttria-doped (A10FY) and yttria-free (A10F) solid solutions.

### DESCRIPTION OF VARIOUS EMBODIMENTS

According to a method of the present invention, a ceramic composite material may be formed by treatment of a solid solution comprising aluminium oxide, a second component comprising a cation in a first valent state, and a dopant.

The solid solution may be prepared using an alumina powder. The alumina powder preferably has a purity of greater than 95%, e.g. greater than 99%, e.g. greater than 99.5%, e.g. greater than 99.9%. The alumina powder preferably comprises α-Al₂O₃. In an embodiment, the alumina powder comprises nano-sized alumina particles. In order to prepare the solid solution, the aluminium oxide may be combined with a dispersing medium such as ethanol or water.

The second component comprises a cation in a first valent state which, as a result of treatment of the solid solution, is changed to a second valent state. By way of illustration, and without limitation, the second component may comprise a trivalent metal ion which can be reduced to a 2+ ion under a reducing treatment, or which can be oxidised to a 4+ ion under an oxidising treatment. Alternatively, a combination of 2+ and 4+ ions can give an “average” state of 3+ in the solid solution. Reduction of the 4+ cation to a 3+ cation may cause destabilisation of the 2+ ions, leading to precipitation from the solid solution.

In an embodiment, the second component comprises Mg and/or Ti. Thus, for instance, Mg²⁺ and/or Ti⁴⁺ may be present in the solid solution. Upon treatment, MgAl₂O₄ and/or Al₂TiO₅ precipitates may be formed. In an embodiment, the solid solution comprises Mg²⁺ and Ti⁴⁺ cations, and treatment of the solid solution reduces the Ti⁴⁺ cations to Ti³⁺.

In an embodiment, the second component comprises a trivalent cation. For example, the second component may be an iron-containing material, e.g. comprising an iron oxide and/or a ferric nitrate. The iron-containing material is preferably one which decomposes upon heating such that iron cations enter the cation sub-lattice of the aluminium oxide to form the solid solution.

In a particular embodiment, the second component comprises iron oxide (Fe₂O₃). It has been found that nano-sized iron oxide particles can be precipitated in an alumina matrix using a processing route based on solution/precipitation of nano-sized oxide particles. Fe₂O₃ (haematite) has the same crystal structure as α-Al₂O₃ (corundum) and possesses substantial solubility in Al₂O₃ at moderately high temperatures in air (about 15 wt % at about 1410° C.). Furthermore, under reducing conditions, Fe³⁺ (of dissolved Fe₂O₃) can be reduced to Fe²⁺, which being aliovalent to Al³⁺ possesses very limited solubility in Al₂O₃. Hence, aging of Al₂O₃—Fe₂O₃ solid solutions, e.g. supersaturated solid solutions, under reducing conditions can lead to the formation of Fe²⁺-containing precipitate particles.

In an embodiment, the solid solution comprises at least 5 wt %, e.g. at least 10 wt %, of the second component based on the weight of the solid solution. In an embodiment, the second component is Fe₂O₃ and is present in an amount of at least 5 wt %, e.g. at least 10 wt %, based on the weight of the solid solution.

The solid solution also comprises a dopant. The dopant is present in the solid solution in an amount of not more than 1000 ppm by weight. In this regard, it has been found that the addition of a dopant in relatively low amounts may affect the formation and/or growth of intergranular particles. In particular, the average size and/or number of intergranular particles may be reduced. Without wishing to be bound by theory, it is thought that the addition of a dopant can result in reduced diffusivities of species along matrix grain boundaries, which may be due to the segregation of cations in the grain boundary regions of the doped polycrystalline aluminium oxide. In this way, the formation and/or growth of particles along the grain boundaries may be suppressed. As a consequence, the properties of a composite material comprising the dopant may be improved compared with materials in which the dopant is absent. In particular, one or more of wear resistance, flexural strength, fracture toughness and impact resistance may be improved. Only small amounts of the dopant may be required to achieve a change in the structure and properties of the material. Indeed, the addition of larger amounts of dopant may be undesirable because it may lead to significant precipitation of particles in the composite material comprising components of the dopant, which may be disadvantageous with respect to certain properties of the material.

In an embodiment, the dopant is present in the solid solution in an amount of less than 1000 ppm by weight of the solid solution. In an embodiment, the dopant is present in an amount of not more than about 500 ppm by weight, e.g. not more than about 250 ppm by weight, e.g. not more than about 200 ppm, by weight of the solid solution. The dopant will normally be added to the solid solution before the treatment step, but may be added at any appropriate stage of the method.

In an embodiment, the dopant comprises a trivalent cation. In an embodiment, the dopant comprises an oxide. For example, the dopant may be added in a form such that it can dissociate to form an oxide in the solid solution.

In an embodiment, the dopant comprises a cation selected from transition metals, lanthanides and actinides. The dopant may comprise one or more such cations and/or one or more other cations. For example, the dopant may comprise a cation of a rare earth element, e.g. selected from the lanthanides, yttrium and scandium. In an embodiment, the dopant comprises a cation selected from Y, Ni, Yb, Er, La, Zr, Nd and V. In a particular embodiment, the dopant comprises an yttrium-containing composition, e.g. yttrium oxide.

The solid solution may be formed by sintering a mixture comprising the aluminium oxide, the second component and the dopant at an elevated temperature. Preferably, a solution treatment step is used in which the cation is distributed in the matrix, preferably at the same time as sintering occurs. The temperature chosen for the sintering will depend on the components used. In an embodiment, sintering is carried out at a temperature of between about 1350 and about 1550° C. For example, sintering may be carried out at a temperature of between about 1400 and 1500° C., e.g. at a temperature of greater than 1425° C. and/or at a temperature of less than 1475° C. In a particular embodiment, sintering is carried out at a temperature of about 1450° C. With regard to Al₂O₃—Fe₂O₃ solid solutions, it has been found that maintaining the temperature of sintering at about 1450° C. may lead to an improved solid solution.

Preferably, the sintering is carried out in air. Whilst different methods are possible, it is preferable to perform the sintering without the application of pressure to the mixture. In an embodiment, the sintering is carried out at ambient pressure. Although the use of a gas atmosphere may increase costs compared with the production of alumina, the cost compared with the conventional methods for producing alumina-based nanocomposite materials may be considerably less. Furthermore, the use of lower pressure, or pressureless, sintering can facilitate the formation of large pieces and/or complex shapes. In a particular embodiment, the solid solution is densified by pressureless sintering.

The solid solution is subjected to a treatment step to form the ceramic composite material. As mentioned above, treatment of the solid solution changes the valent state of cations of the second component to a second valent state.

In an embodiment, the duration of the treatment step ranges from about 0.5 to about 10 hours, e.g. about 5 hours. In an embodiment, the treatment step comprises heating the solid solution at elevated temperature for at least 5 hours, e.g. at least 10 hours, e.g. at least 15 hours, e.g. at least 20 hours. By way of example, the elevated temperature may be at least 1000° C., e.g. at least 1300° C., depending on the composition of the solid solution being treated. In some instances, it may be preferable for the temperature of the treatment step to be less than a particular threshold, e.g. less than 1550° C., e.g. less than 1500° C. In some instances, the solid solution is quenched after treatment. By subjecting the composition to rapid cooling, the risk of precipitation of a secondary phase at this stage can be reduced. However, the composite material may be formed without quenching if desired.

The treatment step may comprise a reducing treatment. In this case, the valency of cations of the second component may be reduced during treatment. For example, where the solid solution comprises iron oxide, Fe³⁺ cations may be reduced to Fe²⁺such that Fe-containing precipitates are formed in the resulting composite material. Fe²⁺ has less solubility in the solid solution than Fe³⁺ and thus particles containing Fe²⁺ will precipitate out of the solid solution during treatment of the solid solution, thereby forming the composite material. Preferably, the iron-containing particles comprise iron oxide compounds. For example, where the solid solution comprises Fe₂O₃, the iron-containing particles may comprise particles of FeAl₂O₄. Control of the treatment step can affect particle size and distribution of the precipitates in the material.

Any suitable treatment may be used to effect the reduction of cations in the solid solution. In an embodiment, the solid solution is placed in a reducing atmosphere at an elevated temperature. The reducing atmosphere may comprise a nitrogen-hydrogen gas mixture. For example, a nitrogen-4% hydrogen-forming gas mixture may be used.

In an embodiment, the solid solution is subjected to a reducing treatment which is carried out at a temperature of between about 1350 and 1550° C. For example, the reducing treatment may be carried out at a temperature of between about 1400 and 1500° C., e.g. at a temperature of greater than 1425° C. and/or at a temperature less than 1475° C. In a particular embodiment, the reducing treatment is carried out at a temperature of about 1450° C. In an embodiment, the duration of the reducing treatment is greater than about 5 hours, e.g. greater than about 10 hours. In an embodiment, the duration of the reducing treatment is less than about 30 hours, e.g. less than about 25 hours. In a particular embodiment, the duration of the reducing treatment is between about 10 and 20 hours.

The treatment step may comprise an oxidation step. In this case, the valency of a cation in the solid solution may be increased. Any appropriate method may be used.

Treatment of the solid solution yields a ceramic composite material comprising grains containing aluminium oxide and a precipitate of particles comprising the cation in the second valent state.

Preferably, the particles precipitate within the grains of the alumina matrix such that the composite material comprises particles comprising the cation in the second valent state within the grains. Such particles are referred to herein as “intragranular particles”. Where reference is made to an alumina or aluminium oxide matrix, it will be understood that, while the major constituent of the matrix material may be alumina, other materials may also be present.

In an embodiment, the material comprises more than 5 wt %, e.g. more than 10 wt %, e.g. more than 15 wt %, e.g. 20 wt % or more of intragranular particles based on the weight of the composite material. In an embodiment, at least 50% by number of the intragranular particles have a diameter of less than about 200 nm. In an embodiment, at least 50%, e.g. at least 70%, e.g. at least 90% of the intragranular particles by number have a size of less than about 200 nm, e.g. less than 150 nm, e.g. less than 100 nm, e.g. less than about 70 nm.

Moreover, intergranular particles may be formed at the boundaries between the alumina grains. In many cases, the size of these intergranular particles may be considerably greater than that of the intragranular particles. In some instances, intergranular particles of several microns in size have been observed. In an embodiment, at least 50% by number of the intergranular particles have a diameter of less than about 4 μm, e.g. less than about 3 μm, e.g. less than about 2 μm, e.g. less than about 1 μm. In an embodiment, at least 50% by number of the intergranular particles have a radius of less than about 2 μm, e.g. less than about 1.5 μm, e.g. less than about 1 μm, e.g. less than about 0.5 μm. In an embodiment, at least 50%, e.g. at least 70%, e.g. at least 90% of the intergranular particles by number have a size of less than about 4 μm, e.g. less than about 3 μm, e.g. less than about 2.5 μm, e.g. less than about 2 μm, e.g. less than about 1.5 μm, e.g. less than about 1 μm, e.g. less than 0.5 μm. In an embodiment, at least 50% by number of the intergranular particles have a radius of less than about 1.5 μm.

In an embodiment, the material comprises particles of one or more of FeAl₂O₄, MgAl₂O₄ and Al₂TiO₅.

In an embodiment, the material comprises grains of alumina-based matrix, intragranular particles of the second component within the grains, and intergranular particles at grain boundaries, wherein at least 50% by number of the intragranular particles have a diameter of not more than 200 nm, and at least 50% by number of the intergranular particles have a diameter of not more than 4 μm, e.g. not more than 2 μm.

In an embodiment, the ratio of the volume fraction of intragranular particles to the volume fraction of intergranular particles is greater than 0.7, e.g. greater than 1.0.

In an embodiment, the ceramic composite material comprises a dopant in an amount of not more than about 500 ppm by weight, e.g. not more than about 250 ppm by weight, e.g. not more than about 200 ppm by weight.

Materials described herein may find wide application. For example, the materials may be used to form components for use in industry, such as e.g. blades and channels in papermaking apparatus, thread guides in the textile industry, nozzles and valve parts for use in equipment managing abrasive slurries. The materials may also be used in lightweight body armour and vehicle armour. It is anticipated that the materials described herein and other materials provided by aspects of the invention can find application in any area where alumina is presently used. It will be understood that the features of the invention described herein are not limited to any particular application of the material.

The present disclosure is also directed to the use of a dopant material in a method of forming a ceramic composite material, the composite material comprising grains of alumina-based matrix, the dopant material suppressing the formation and/or growth of intergranular particles. The disclosure is also directed to the use of a dopant material in a method of forming a ceramic composite material by precipitation of particles from a solid solution, the dopant material suppressing the growth of particles at the boundary of grains of the ceramic matrix. The dopant material may improve one or more properties of the material selected from wear resistance, flexural strength, fracture toughness and impact resistance.

It will also be understood that the methods disclosed herein may be used to produce ceramic materials other than those having alumina as the matrix material. Thus, the present disclosure is also directed to a method of forming a ceramic composite material, the method comprising the steps of: preparing a solid solution comprising a ceramic matrix material, a second component comprising a cation in a first valent state, and a dopant, wherein the dopant is present in an amount of not more than 1000 ppm by weight of the solid solution; and carrying out a treatment on the solid solution to form the ceramic composite material, wherein the treatment changes the valent state of said cation to a second valent state, forming a composite material comprising grains containing matrix material and a precipitate of particles comprising the cation in the second valent state. The resulting materials may have improved mechanical and tribological properties compared with the matrix material alone.

The following non-limiting Example illustrates the present invention.

### Example

### Production of Alumina-Based Composite Materials

α-Al₂O₃ powders (99.995% purity; AKP50, Sumitomo, Japan) of particle size of about 0.2 μm were used as the starting material for the matrix (Al₂O₃). In order to inhibit abnormal grain growth during sintering and to enable near theoretical densification, the Al₂O₃ powders were doped with 250 ppm of MgO using pure MgO powders (99.95%; 120 nm; UBE, Japan). The MgO-doped Al₂O₃ powders were dispersed in ethanol using an ultrasonic probe. Fe³⁺ was incorporated by adding a solution of Fe(NO₃)₃.9H₂O (Sigma Aldrich, UK, purity >98%) in ethanol to the alumina slurries. The Fe(NO₃)₃ solutions contained requisite amount of the salt corresponding to 10 wt % Fe₂O₃ in Al₂O₃. In order to study the effects of small amounts of Y₂O₃ addition (250 ppm by weight) on the microstructural developments, requisite amounts of Y(NO₃)₃.6H₂O dissolved in ethanol were also added to some of the slurries. Pure alumina slurries were also made for comparison. The slurries were ball milled for 24 hours in bottles made of polyethylene using high purity (99.99%) alumina balls. After ball milling, the slurries were dried on a hot plate with constant stirring using a magnetic stirrer. The dried powders were ground in an Al₂O₃ mortar and pestle, and passed through a 150 μm sieve. Green compacts were produced by uniaxial cold pressing of the powders into 20 mm discs at 100 MPa, which were then sintered via pressureless sintering at 1450° C. for 5 h in air inside an alumina tube furnace (Lenton, UK). After sintering, the samples were then quenched by pushing them immediately to the end of the furnace tube using an alumina rod. The supersaturated solid solutions were then aged in a tube furnace with capped ends in a N₂+4% H₂ forming gas mixture at 1450° C. and 1550° C. for different durations (up to 20 h) to form the composite materials.

The alumina samples containing about 10 wt % Fe₂O₃ are referred to herein as “A10F”, and the samples additionally doped with Y₂O₃ (250 ppm) are referred to as “A10FY”.

### Structure of the Materials

Density measurements revealed that pressureless sintering of monolithic Al₂O₃, A10F and A10FY resulted in sinter densities of more than 98% of theoretical densities. XRD investigations indicated that Fe₂O₃ (approximately 10 wt %) was effectively completely dissolved in Al₂O₃ during holding at the sintering temperature of 1450° C. for both the A10F and A10FY samples. By contrast, additional peaks corresponding to FeAl₂O₄ (iron aluminate spinel) were observed after aging of the solid solutions at 1450° C. and 1550° C. in a reducing atmosphere (N₂+4% H₂ gas mixture), indicating that iron-containing precipitates had formed during the reducing treatment.

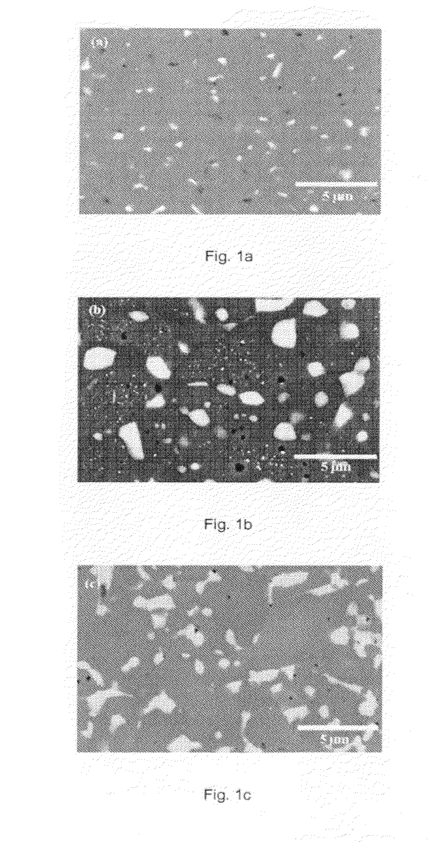

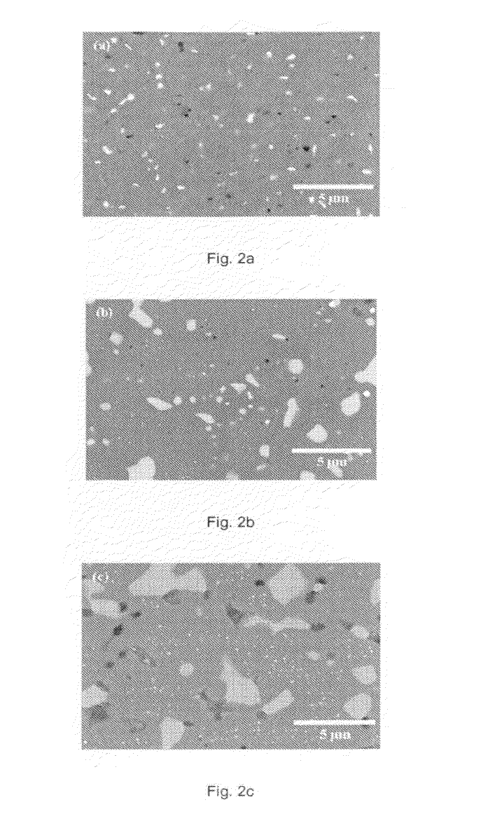

BSE-SEM images obtained from ground and polished surfaces of A10F and A10FY, aged at 1450° C. and 1550° C. for different durations (0 to 20 h) in the reducing atmosphere, are shown in FIGS. 1a to c and FIGS. 2a to c. FIGS. 1a to c show the images for A10F solid solution (no yttria) after treatment at 1450° C. for 0 h (FIG. 1a), 1450° C. for 20 h (FIG. 1b), and 1550° C. for 0 h (FIG. 1c). FIGS. 2a to c show the images for A10FY solid solution (doped with Y₂O₃ at about 250 ppm) after treatment at 1450° C. for 0 h (FIG. 2a), 1450° C. for 20 h (FIG. 2b), and 1550° C. for 0 h (FIG. 2c). Table 1 shows the effects of yttria-doping on the presence and sizes of the inter- and intra-granular second phase (FeAl₂O₄) particles formed on aging of Al₂O₃—Fe₂O₃ solid solutions in a reducing atmosphere (N₂+4% H₂) at 1450° C. and 1550° C., as estimated from BSE-SEM images.

TABLE 1

| | Reduction aging temperature: 1450° C. | | | | Reduction aging temperature: 1550° C. | | | |
|---|---|---|---|---|---|---|---|---|
| | Yttria-free | | Yttria-doped | | Yttria-free | | Yttria-doped | |
| | Intergranular | Intragranular | Intergranular | Intragranular | Intergranular | Intragranular | Intergranular | Intragranular |
| Aging | particles | particles | particles | particles | particles | particles | particles | particles |
| time (h) | size (μm) | size (nm) | size (μm) | size (nm) | size (μm) | size (nm) | size (μm) | size (nm) |
| 0 | 1.1 ± 0.6 | Not present | 0.6 ± 0.3 | Not present | 2.9 ± 0.6 | Not present | 2.2 ± 0.4 | 27 ± 19 |
| 5 | 1.5 ± 0.8 | Not present | 0.7 ± 0.9 | 29 ± 7 | 5.4 ± 0.8 | 79 ± 17 | 4.8 ± 0.3 | 74 ± 11 |
| 10 | 1.7 ± 0.5 | 71 ± 27 | 0.9 ± 0.6 | 68 ± 14 | Not measured | 88 ± 19 | Not measured | 102 ± 16 |
| | | | | | due to excessive | | due to excessive | |
| | | | | | pull out | | pull out | |
| 15 | 1.9 ± 0.5 | 104 ± 38 | 1.2 ± 0.7 | 92 ± 11 | Not measured | 119 ± 47 | Not measured | 114 ± 28 |
| | | | | | due to excessive | | due to excessive | |
| | | | | | pull out | | pull out | |
| 20 | 2.2 ± 0.3 | 127 ± 34 | 1.2 ± 0.3 | 108 ± 22 | Not measured | 153 ± 29 | Not measured | 159 ± 17 |
| | | | | | due to excessive | | due to excessive | |
| | | | | | pull out | | pull out | |

During reduction aging of the A10F solid solutions, only micron-sized grain boundary particles appeared during the initial stages (0-5 h; see FIG. 1a and Table 1). With continued aging for durations of 10 hrs or more at 1450° C., extremely fine nano-sized second phase particles (˜70 nm) precipitated within the matrix grains, along with the continuing presence of the coarser micron-sized intergranular particles, resulting in the development of a hybrid nano/micro composite microstructure. On further aging (up to 20 h), modest coarsening of both the intergranular and intragranular particles occurred. Although the intragranular particles still maintained their nanoscale dimensions (˜120 nm), the intergranular particles grew up to −2 μm in size (see FIG. 1b and Table 1). Compared to the samples aged at 1450° C., much coarser intergranular FeAl₂O₄ particles (˜3 μm) were formed even during the initial stages of aging (˜0 h; see FIG. 1c) at the higher temperature of 1550° C., followed by extremely rapid growth during continued aging (see Table 1). Indeed, after just 10 h of aging at 1550° C., development of coarse and inter-connected network of intergranular FeAl₂O₄ particles resulted in considerable pull outs of these particles during metallographic polishing, which did not allow accurate estimation of the particle sizes.

The suppression of growth of the intergranular precipitate particles during reduction aging of the yttria-doped solid solutions (A10FY) was seen. With reference to FIG. 2 and Table 1, it can be observed that, in addition to the nano-sized intragranular second phase particles (FeAl₂O₄), submicron-sized intergranular particles appear in such nanocomposites. These intergranular particles are considerably finer (by a factor of about 2) than the intergranular micron-sized particles present in the nanocomposites developed via aging of the A10F solid solutions for the same durations at 1450° C. Moreover, aging at 1450° C. gave a different microstructure compared with aging at 1550° C.

Table 2 shows the ratio of volume fraction of intragranular particles to volume fraction of intergranular particles (R) obtained during reduction aging of the yttria-free (A10F) and yttria-doped (A10FY) solid solutions at 1450° C.

TABLE 2

| | R obtained during aging of | R obtained during aging of |
|---|---|---|
| Aging duration | yttria-free solid solutions | yttria-doped solid solutions |
| at 1450° C. (h) | (A10F) | (A10FY) |
| 0 | 0 | 0 |
| 5 | 0 | 0.2 ± 0.07 |
| 10 | 0.3 ± 0.07 | 0.7 ± 0.02 |
| 15 | 0.5 ± 0.04 | 1.0 ± 0.08 |
| 20 | 0.9 ± 0.06 | 1.2 ± 0.14 |

It can be seen that the relative amounts of the intragranular nano-sized particles, with respect to the coarser intergranular particles, increase with aging duration up to 20 h. It can also be seen that aging of the yttria-containing solid solution (A10FY) results in the generation of higher relative amounts of intragranular particles, with respect to aging of A10F, at the corresponding aging durations. Also, a higher volume fraction of intragranular particles as compared to intergranular particles can be achieved on yttria-doping.

The fracture surfaces of the monolithic alumina, solid solutions and the nanocomposites were observed using scanning electron microscopy (SEM). The monolithic alumina, A10F and A10FY solid solutions exhibited intergranular mode of fracture, as did the material developed on aging for 0 h at both the aging temperatures. By contrast, the nanocomposite materials developed on aging for longer durations (10 and 20 h) fractured in the transgranular mode.

Transmission electron microscopy (TEM) showed the size and distribution of the intragranular second phase particles more clearly. A high density of genuinely nano-scale FeAl₂O₄ particles was visible inside the matrix grains and there was a precipitate-free zone of width ˜100 nm at the grain boundary. Occasionally holes (˜2 μm in size) were observed along the boundaries or triple point corners of the matrix grains in the foils developed from the nanocomposites obtained on aging A10F for 20 h. Such holes appear to have been formed due to the coarser intergranular particles falling out during the TEM sample preparation. With regard to the as aged yttria-doped samples (A10FY), the presence of comparatively finer intergranular particles, as compared to those in the A10F samples aged for the same durations at 1450° C., was seen from TEM observations. Also, holes formed from falling out of the intergranular particles during TEM sample preparation were not observed for the yttria-doped nanocomposites.

### Wear Resistance of the Materials

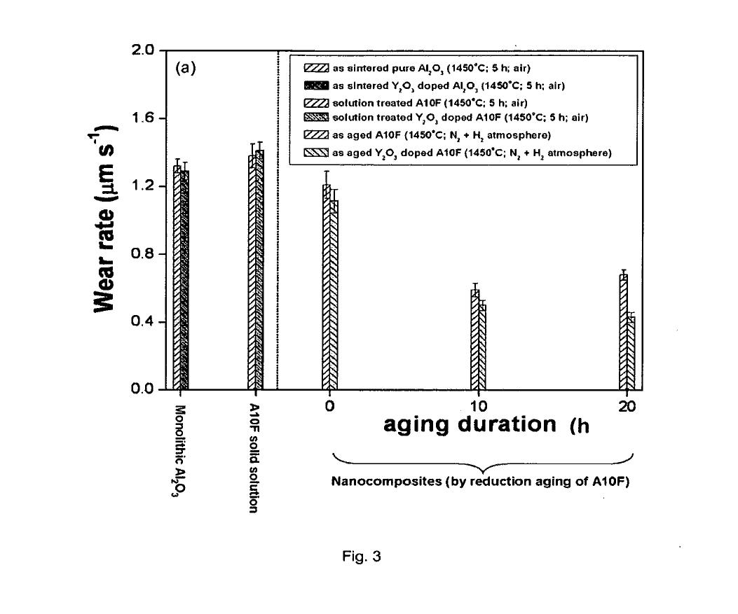

A comparison of the abrasive wear rates, as measured for monolithic alumina, Al₂O₃—Fe₂O₃ solid solutions and the Al₂O₃—FeAl₂O₄ nanocomposites developed on reduction aging at 1450° C., both in the presence and absence of yttria (˜250 ppm) is shown in FIG. 3. Doping with only about 250 ppm of Y₂O₃ resulted in lowering of the wear rates for these nanocomposites. Y₂O₃ doping appeared to have the most significant influence on the wear resistance of the nanocomposite developed by aging for 20 h at 1450° C. (by a factor of ˜1.6, compared with the corresponding specimen without yttria). This nanocomposite exhibited an average wear rate of about 0.45 μm/s, as against the wear rate of about 1.25 μm/s recorded with monolithic alumina of similar grain size. Hence, the results of these abrasive wear tests reveal that the yttria-doped Al₂O₃—FeAl₂O₄ nanocomposites developed at preferred aging conditions of 1450° C. for 20 h possess significantly enhanced wear resistance (by a factor of about 2.5) as compared to that of monolithic alumina.

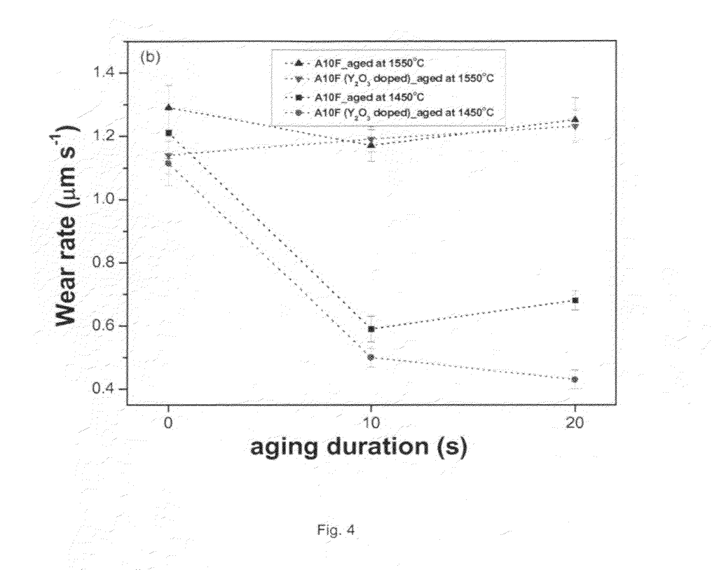

FIG. 4 presents the wear rates obtained with the nanocomposites developed at the higher reduction aging temperature of 1550° C. For comparison, the wear rates recorded with the nanocomposites at the lower aging temperature (1450° C.) are also presented. It can be seen that the nanocomposites developed at the higher aging temperature possessed inferior wear resistance in this example with respect to those developed by aging at 1450° C. Additionally, unlike for the nanocomposites developed at 1450° C., no significant variation in the wear rates with aging time could be seen within the limits of the experimental error. The wear rates in the absence of yttria-doping varied between 1.2 μm/s to 1.3 μm/s, which are similar to those recorded with monolithic alumina. It will be appreciated that different results may be obtained in respect of other processes and materials.

### Hardness of the Materials

The room temperature hardness (Hᵥ), as obtained with Vickers indentations (indentation load: 5 kg), are reported in Table 3.

TABLE 3
Vickers hardness (Hᵥ₅; GPa), as measured with 5 kg indentation load.

| Materials | Yttria-free | Yttria-doped | Yttria-free | Yttria-doped |
|---|---|---|---|---|
| Monolithic Al₂O₃ | 20.1 ± 0.4 | — | | |
| (as sintered; | | | | |
| 1450° C.; 5 h) | | | | |
| A10F solid solution; | 17.1 ± 0.8 | 16.9 ± 0.9 | | |
| (as sintered; | | | | |
| 1450° C.; 5 h) | | | | |
| | Aging temperature: | | Aging temperature: | |
| Aged samples | 1450° C. | | 1550° C. | |
| Al₂O₃—FeAl₂O₄ | 17.8 ± 0.3 | 17.4 ± 0.4 | 17.1 ± 0.4 | 17.2 ± 0.5 |
| (aged in N₂ + | | | | |
| H₂ for 0 h) | | | | |
| Al₂O₃—FeAl₂O₄ | 17.7 ± 0.5 | 18.2 ± 0.2 | 16.8 ± 0.6 | 16.4 ± 0.3 |
| (aged in N₂ + | | | | |
| H₂ for 5 h) | | | | |
| Al₂O₃—FeAl₂O₄ | 18.6 ± 0.2 | 18.9 ± 0.5 | 16.8 ± 0.2 | 17.1 ± 0.8 |
| (aged in N₂ + | | | | |
| H₂ for 10 h) | | | | |
| Al₂O₃—FeAl₂O₄ | 18.8 ± 0.6 | 19.5 ± 0.4 | 16.2 ± 1.7 | 15.9 ± 0.9 |
| (aged in N₂ + | | | | |
| H₂ for 15 h) | | | | |
| Al₂O₃—FeAl₂O₄ | 18.4 ± 0.7 | 19.1 ± 0.8 | 15.6 ± 1.9 | 15.9 ± 1.5 |
| (aged in N₂ + | | | | |
| H₂ for 20 h) | | | | |

The samples developed on reduction aging at 1450° C. for 0 to 20 h possessed a hardness of between 18-19 GPa, which is comparable to that of pure alumina (˜20 GPa) and slightly improved with respect to that of A10F and A10FY solid solutions (˜17 GPa). The nanocomposites developed on aging the yttria-doped solid solutions possessed higher hardness with respect to the nanocomposites developed by aging of the A10F solid solutions. Table 3 indicates that the hardness was considerably reduced on aging at the higher temperature of 1550° C., although accurate determination was difficult in the presence of extensive pull outs.

### Fracture Toughness and Flexural Strength of the Materials

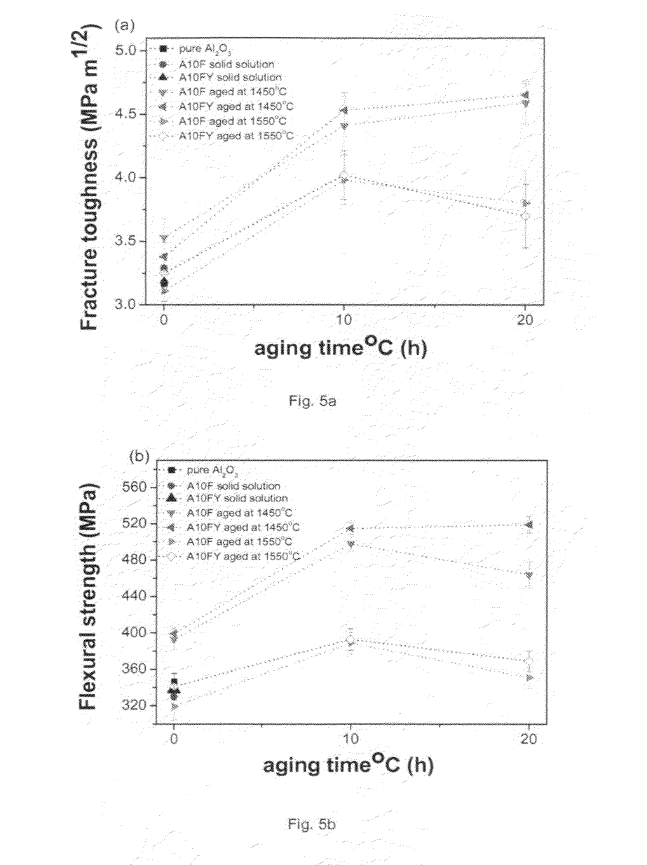

FIGS. 5a and 5b present the room temperature fracture toughness (K_{lc}) and flexural strength (σ_{f}) of the nanocomposites, developed on reduction aging of the yttria-free (A10F) and the yttria-doped (A10FY) solid solutions. The toughness and strengths of both the solid solutions (A10F and A10FY) were similar to that of pure Al₂O₃. A modest increase in the fracture toughness (by ˜0.3 MPa m^{1/2}), with respect to that of pure Al₂O₃, was obtained on aging the A10F solid solution at 1450° C. for 0 h (see FIG. 5b). With increasing aging duration, the fracture toughness was observed to improve progressively for the nanocomposites developed from both the solid solutions (A10F and A10FY). A maximum improvement of fracture toughness by ˜45% (K_{lc}˜4.7 MPa m^{1/2}), with respect to pure Al₂O₃, was obtained on aging the A10FY solid solution for 20 h at 1450° C. With regard to the errors in measurement, not much difference was observed between the fracture toughness of the nanocomposites developed with A10FY and those developed with A10F solid solution on aging for durations longer than 0 h. As against aging at 1450° C., no improvement in fracture toughness was observed on aging for 0 h at 1550° C. in the presence or absence of yttria. With continued aging, improvement in fracture toughness was observed after 10 h at 1550° C. However, such improvement was considerably lower than those obtained on aging for the same duration at 1450° C. On aging for still longer duration of 20 h, a modest reduction in the fracture toughness was observed. Similar to aging at 1450° C., yttria addition did not have any notable effect on the fracture toughness improvements achieved after aging at 1550° C.

Flexural strength was found to improve considerably on aging both the solid solutions at 1450° C., especially for 10 and 20 h (see FIG. 5b). Although yttria addition did not have any effect on the strength improvement obtained on aging for 0 h, the strengths of the nanocomposite developed by continued aging were further improved in the presence of yttria-doping. In particular, aging of A10FY for 20 h did not lead to any deterioration of strength with respect to that obtained on aging for 10 h, which is contrary to that observed on aging of A10F. The strength of the nanocomposite developed on aging the yttria-doped solid solution for 20 h at 1450° C. was higher by ˜55 MPa with respect to the nanocomposite developed by aging A10F for the same duration. Hence, a maximum improvement in flexural strength of ˜50% (σ_{f}˜520 MPa) over that of monolithic Al₂O₃ was obtained with the nanocomposite developed on aging A10FY for 20 h at 1450° C.

### Observation of the Worn Surfaces

In order to gain an insight into the wear mechanisms, topographical observations of the worn surfaces were made using SEM. The worn surfaces of monolithic alumina show the classical features of extensive pullout, whereby large pieces of material are removed by brittle fracture. The average pullout diameter has been estimated to be about 4.5 μm, which is larger than the Al₂O₃ grain size (about 3 μm). Such pullouts occupy an area fraction of about 53%. Closer inspection of the pulled out regions revealed that such pullout formation appears to have occurred due to intergranular fracture. Similar to that of alumina, the worn surfaces of A10F solid solutions can also be characterised by the presence of extensive intergranular fracture induced pullouts. Due to the extremely rough topography of the worn surfaces, with nearly about 80% of the area of the surfaces showing the presence of pullouts, precise estimation of the pullout size and area fraction occupied by pullouts could not be made.

The worn surfaces of the nanocomposites developed on aging of A10F solid solutions and A10FY solid solutions at 1450° C. were observed. The effect of yttria doping on the appearance of the worn surfaces of the nanocomposites developed by reduction aging at 1450° C. was investigated. It was seen that the surfaces for the unaged samples are quite similar, since intergranular fracture induced pullouts also occurred during the abrasive wear of the composite developed on aging for 0 h. By contrast, the worn surfaces of the yttria-doped nanocomposites developed on aging for 10 h and 20 h appear to be almost completely devoid of any kinds of pullouts, in contrast to the undoped composite materials.

The suppression of pullouts for the nanocomposites can be correlated with the change in fracture mode to transgranular, which in turn can be correlated with the appearance of nano-sized second phase particles on reduction aging for durations longer than 0 h at 1450° C. The analysis indicates that the presence of intragranular nano-sized second phase particles is beneficial for the wear resistance of alumina, as opposed to the presence of coarser intergranular particles. As discussed above, the dopant may suppress the formation of relatively coarse intergranular particles.

### Intragranular Particles

Polishing of the indents on monolithic alumina using a 0.1 μm diamond paste led to the formation of pullouts in the as polished indentation plastic zone, whereas such pullout formation was suppressed in the nanocomposite materials developed on aging for 20 h at 1450° C. The absence of such pullouts in the plastic zone of the nanocomposite may indicate the ability of the nano-sized second phase particles to suppress crack initiation during deformation.

It is known that compressive deformation, indentation, grinding and abrasive wear can result in the formation of deformation bands, mainly in the form of twins in alumina. Furthermore, it has been observed that intersection of such twins and dislocation pile ups with the grain boundaries can result in the initiation of micro-cracks and eventually grain boundary failure or intergranular fracture. It has also been observed that such grain boundary cracking due to intersection of the deformation bands occurs mainly above a critical grain size. In other words, as the grain size of monolithic alumina increases, the lengths of the twins and the dislocation pile ups intersecting with the grain boundaries also can increase, and above a critical size, the stress concentrations at the heads of such deformation bands evidently become sufficient to initiate grain boundary cracks in alumina. Without wishing to be bound by theory, it is believed that nano-sized second phase particles present within the matrix grains may act as obstacles to the formation of the twins and dislocations and concomitantly reduce their lengths and the stress concentration at their tips. Thus, there may be a role of intragranular nano-sized particles in preventing the grain boundary fracture of alumina matrix grains.

### Effect of Coarser Intergranular Particles

The worn surfaces of nanocomposites present evidence of pullouts occurring due to the falling out of the coarser, micron sized second phase particles, which were mostly present along the matrix grain boundaries. It was further noted that the frequency of occurrence of such pullouts increased with the increase in aging duration, which in turn is correlated with the increase in average size of such intergranular second phase particles. Additionally, the coarse intergranular particles, present in the nanocomposites developed after aging for 20 h, have also been observed to fall out during preparation of TEM samples and fracture during bend tests. By contrast, the nano-sized intragranular particles have rarely been observed to fall out in any of the processes.

Considering that the thermal expansion coefficients of the matrix (Al₂O₃; αₘ˜8×10⁻⁶ K⁻¹) and the second phase particles (FeAl₂O₄; αₚ˜13×10⁻⁶ K⁻¹) are different, the contraction rates will be different for the two phases during cooling from the heat treatment temperatures. Due to this differential contraction rate, stresses develop within the phases and at the Al₂O₃/FeAl₂O₄ interfaces. Development of such stresses can effectively weaken the particle/matrix interfaces and even lead to spontaneous cracking at the interfaces, especially above a certain critical size of the second phase particles. Furthermore, when the second phase particles, possessing higher thermal expansion coefficients, contract more than the matrix during cooling, such spontaneous cracks are expected to develop circumferentially around the particles. Calculations suggest that second phase particles of sizes greater than about 2 μm (4 μm diameter in some examples) are likely to develop spontaneous cracks along their interfaces with the matrix. Furthermore, it is thought that since the stiffness of the second phase particles is different from that of the matrix, the particle/matrix interfaces of the coarser particles are more vulnerable towards cracking due to stress magnification in the vicinity of the particles during application of external stresses.

It is thought that the above factors may give rise to the occurrence of extensive pullouts due to the intergranular particles falling out during wear of the nanocomposites, causing the wear rate to increase with increase in aging time from 10 h at 1450° C. Hence, the presence of such coarser intergranular particles, especially above a certain size of about 2 μm as is present in the Al₂O₃—FeAl₂O₄ nanocomposites (without the addition of the dopant), developed by aging for durations greater than 10 h at 1450° C. (see Table 1), may be deleterious with regard to wear resistance. It can be further observed that with yttria-doping, the average size of the intergranular particles, even after aging for 20 h, may be reduced to about 1.2 μm (see Table 1), which is below the critical limit. It is quite likely that this effect on particle size leads to a reduction in pullout of the intergranular particles and concomitantly the measured wear rate.

In conclusion, it can be seen that yttria-doping resulted in a reduction of the sizes of the intergranular second phase (FeAl₂O₄) particles formed during aging of the Al₂O₃—Fe₂O₃ solid solutions in reducing atmosphere (N₂+4% H₂). Also aging of the yttria-containing solid solution (A10FY) resulted in the generation of higher relative volume fractions of intragranular particles, with respect to aging of A10F, at all the aging durations. Moreover, the Al₂O₃—FeAl₂O₄ nanocomposites developed by reduction aging at 1450° C. for durations of 10 and 20 h were found to be more wear resistant as compared to monolithic alumina. Furthermore, the presence of small amounts of yttria (e.g. about 250 ppm yttria) further improved the wear resistance of the nanocomposites developed at 1450° C., with the nanocomposite developed after 20 h of reduction aging exhibiting a particularly advantageous wear rate, which is significantly less (by a factor of about 2.5) than that recorded in respect of monolithic alumina. The suppression of brittle intergranular fracture induced grain pull outs in the presence of intragranular nanosized second phase particles is believed to be the major factor responsible for the improved wear resistance of the nanocomposite materials with respect to monolithic alumina. The presence of a dopant can suppress the formation of the intergranular particles, thereby improving wear resistance.

It will be understood that the present invention has been described above purely by way of example, and modification of detail can be made within the scope of the invention. Each feature disclosed in the description, and (where appropriate) the claims and drawings may be provided independently or in any appropriate combination. Any feature in one aspect of the invention may be applied to other aspects of the invention, in any appropriate combination. In particular, method aspects may be applied to product aspects, and vice versa.

1. A method of forming a ceramic composite material, the method comprising the steps of:
preparing a solid solution comprising aluminium oxide, a second component comprising a cation in a first valent state, and a dopant, wherein the dopant is present in an amount of not more than 1000 ppm by weight of the solid solution; and
carrying out a treatment on the solid solution to form the ceramic composite material, wherein the treatment changes the valent state of said cation to a second valent state, forming a ceramic composite material comprising grains containing aluminium oxide and a precipitate of particles comprising the cation in the second valent state.

2.-4. (canceled)

5. A method according to claim 1, wherein the dopant is present in an amount of not more than 500 ppm by weight, or not more than 250 ppm by weight, of the solid solution.

6. A method according to claim 1, wherein the dopant comprises a cation selected from transition metals, lanthanides and actinides.

7. A method according to claim 6, wherein the dopant comprises a cation of a rare earth element.

8. A method according to claim 1, wherein the dopant comprises an yttrium-containing composition.

9. A method according to claim 1, wherein the dopant comprises an oxide.

10. A method according to claim 1, wherein the dopant comprises a trivalent cation.

11. A method according to claim 1, wherein the second component comprises Mg, Ti or an iron cation.

12. (canceled)

13. A method according to claim 1, wherein the treatment step comprises heating the solid solution at an elevated temperature for at least 5 hours, or at least 10 hours, or at least 15 hours, or at least 20 hours; wherein the elevated temperature is optionally at least 1000° C., or at least 1300° C.

14-18. (canceled)

19. A method according to claim 1, wherein the treatment step comprises an oxidation step and the valency of said cation of the second component is increased during the treatment step; or wherein the treatment step comprises a reducing treatment, wherein said reducing treatment optionally comprises placing the solid solution in a reducing atmosphere at an elevated temperature.

20. A method according to claim 1, wherein the solid solution is prepared by sintering a mixture comprising the aluminium oxide, the second component and the dopant at an elevated temperature.

21. A method according to claim 1, wherein the solid solution comprises at least 5 wt %, or at least 10 wt %, of the second component based on the weight of the solid solution.

22. (canceled)

23. A ceramic composite material obtainable by a method comprising the steps of:
preparing a solid solution comprising aluminium oxide, a second component comprising a cation in a first valent state, and a dopant, wherein the dopant is present in an amount of not more than 1000 ppm by weight of the solid solution; and
carrying out a treatment on the solid solution to form the ceramic composite material, wherein the treatment changes the valent state of said cation to a second valent state, forming a ceramic composite material comprising grains containing aluminium oxide and a precipitate of particles comprising the cation in the second valent state.

24. A material according to claim 23, wherein the composite material comprises particles comprising the cation in the second valent state within the grains.

25. A material according to claim 24, wherein at least 50% by number of the particles within the grains have a diameter less than about 200 nm.

26. A material according to claim 24, wherein the material comprises more than 5 wt %, or more than 10 wt %, or more than 15 wt %, or 20 wt % or more of intragranular particles based on the weight of the composite material.

27. A material according to claim 23, wherein the material comprises intergranular particles at boundaries between the grains, wherein at least 50% by number of the intergranular particles have a diameter of less than about 4 μm, or less than about 2 μm, or less than about 1 μm.

28. A material according to claim 23, wherein the material comprises grains of alumina-based matrix, intragranular particles of the second component within the grains, and intergranular particles at grain boundaries, wherein at least 50% by number of the intragranular particles have a diameter of not more than 200 nm, and wherein at least 50% by number of the intergranular particles have a diameter of not more than 2 μm.

29-32. (canceled)

33. A product comprising a ceramic composite material of claim 23.

34. A product according to claim 33, wherein the product is a wear resistant material, body armour or vehicle armour.

35. (canceled)
